(19) United States
(12) Patent Application Publication
(10) Pub. No.: US 2012/0100027 A1
(43) Pub. Date: Apr. 26, 2012

(54) Internal-Rotation Type Gear Pump and Method of Assembling and Repairing an Internal-Rotation Type Gear Pump

(76) Inventor: Ding-Guey Liu, New Taipei City (TW)

(21) Appl. No.: 13/234,203

(22) Filed: Sep. 16, 2011

(30) Foreign Application Priority Data
Oct. 20, 2010 (TW) 099135697

(51) Int. Cl. F04C 27/00; B23P 6/00

(52) U.S. Cl. 418/104; 29/888.021

(57) ABSTRACT

A method of assembling and repairing an internal-rotation type gear pump has a preparing step, a disassembling step, a taking step, a repairing step and an assembling step. The preparing step includes preparing an internal-rotation type gear pump with a bearing mount device, a gland-sealing device and a pump device with a casing, a side cover, a driven gear and a driving gear. The disassembling step includes disassembling the side cover from the casing and disassembling and separating the gears from the driving shaft. The taking step includes separating and taking the gland-sealing device from the casing. The repairing step includes repairing the mechanisms inside the internal-rotation type gear pump and replacing with a new one if one of the mechanisms is broken. The assembling step includes putting the gland-sealing device into the casing, assembling the driving gear on the driving shaft and assembling the side cover on the casing.

### BACKGROUND OF THE INVENTION

1. Field of the Invention

The present invention relates to a method of assembling and repairing an internal-rotation type gear pump to assemble and repair the internal-rotation type gear pump conveniently.

2. Description of the Prior Arts

In general, a conventional internal-rotation type gear pump is used to compress and transfer liquid and has a mechanical gland seal mounted in a chamber of the conventional internal-rotation type gear pump to limit and hold the liquid flowing in the chamber. The mechanical gland seal of the conventional internal-rotation type gear pump can be used to prevent liquid from flowing to/in other areas of the conventional internal-rotation type gear pump to avoid damaging other mechanisms inside the conventional internal-rotation type gear pump.

With reference to FIG. 7, a conventional internal-rotation type gear pump has a bearing mount 60, a driving shaft 61, a mechanical gland seal 70 and a pump device 80. The bearing mount 60 is hollow and has a front end, a rear end, a middle, two openings, two mounting bases 621, two bearings 62 and two bearing caps. The openings are respectively formed in the ends of the bearing mount 60. The mounting bases 621 are respectively formed on and protrude form the middle and the rear end of the bearing mount 60 and each mounting base 621 has a mounting hole 622 and an outer side. The bearings 62 are respectively mounted in the mounting holes 622 of the mounting bases 621. The bearing caps are respectively mounted on the outer sides of the mounting bases 621 by fasteners. The driving shaft 61 is rotatably mounted in the bearing mount 60 and has a front end and a rear end respectively extending out of the openings of the bearing mount 60. The rear end of the driving shaft 61 may be connected to a motor. The mechanical gland seal 70 is mounted in the bearing mount 60 and is mounted around the driving shaft 61 near the front end of the driving shaft 61.

The pump device 80 is connected to the bearing mount 60, is mounted around the driving shaft 61 near the front end of the driving shaft 61 and has a casing 81, a side cover 82, a driven gear 831 and a driving gear 83. The casing 81 is connected to the front end of the bearing mount 60 and has a sealing sheath 811 and a sealing cover 812. The sealing sheath 811 is mounted in the bearing mount 60, is mounted around the driving shaft 61 to hold the mechanical gland seal 70 and has a rear side. The sealing cover 812 is securely connected to the rear side of the sealing sheath 811 and is mounted around the driving shaft 61. The driving gear 83 is securely mounted around the front end of the driving shaft 61 and is rotatably mounted in the casing 81. The driven gear 831 is mounted in the casing 81 and engages the driving gear 83. The gears 83, 831 in the casing 81 can be used to compress and transfer liquid in the conventional internal-rotation type gear pump by the motor and the driving shaft 61.

When the conventional internal-rotation type gear pump is used for a long period of time, the mechanisms inside the conventional internal-rotation type gear pump may be broken and need to be repaired. If the mechanical gland seal 70 is broken, worn or torn, one of the disassembling methods is disassembling the motor from the driving shaft 61, loosening the fasteners to separate the bearing caps from the mounting bases 621 and disassembling the bearing mount 60 and the bearings 62 from the pump device 80. Then, a user can repair the mechanical gland seal 70 between the sealing sheath 811 and the sealing cover 812. The other disassembling method is disassembling the side cover 82, the driven gear 831 and the driving gear 83 from the casing 81 in consecutive order and disassembling the driving shaft 61 from the bearing mount 60 and the motor to repair the mechanical gland seal 70.

However, the described conventional disassembling methods requires disassembling the driving shaft 61 or the pump device 80 from the bearing mount 60 and then reassembling back in position the disassembled mechanisms (such as the driving shaft 61, the bearing mount 60, the bearings 62 or the casing 81) after maintenance, and this is time-consuming and is inconvenient in use.

To overcome the shortcomings, the present invention provides a method of assembling and repairing an internal-rotation type gear pump to mitigate or obviate the aforementioned problems.

### SUMMARY OF THE INVENTION

The main objective of the present invention is to provide a method of assembling and repairing an internal-rotation type gear pump that can assemble and maintain the internal-rotation type gear pump conveniently.

The method of assembling and repairing an internal-rotation type gear pump in accordance with the present invention has a preparing step, a disassembling step, a taking step, a repairing step and an assembling step. The preparing step includes preparing an internal-rotation type gear pump with a bearing mount device, a gland-sealing device and a pump device with a casing, a side cover, a driven gear and a driving gear. The disassembling step includes disassembling the side cover from the casing via a front opening and disassembling and separating the gears from the driving shaft. The taking step includes separating and taking the gland-sealing device from the driving shaft and the casing. The repairing step includes repairing the mechanisms inside the internal-rotation type gear pump and replacing with a new one if one of the mechanisms is broken. The assembling step includes putting the gland-sealing device into the casing via the front opening to mount around the driving shaft, assembling the driving gear on the driving shaft and assembling the side cover on the casing to close the front opening and to enable the driven gear to engage the driving gear.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of a method of assembling and repairing an internal-rotation type gear pump in accordance with the present invention;

FIG. 2 is a side view in partial section of an internal-rotation type gear pump in accordance with the present invention;

FIG. 3 is a perspective view of the internal-rotation type gear pump in FIG. 2 without a bearing mount;

FIG. 4 is an exploded perspective view of the internal-rotation type gear pump in FIG. 3;

FIG. 5 is a perspective view in partial section of the internal-rotation type gear pump in FIG. 3;

FIG. 6 is an enlarged side view in partial section of the internal-rotation type gear pump in FIG. 3; and

FIG. 7 is a side view in partial section of a conventional internal-rotation type gear pump in accordance with the prior art.

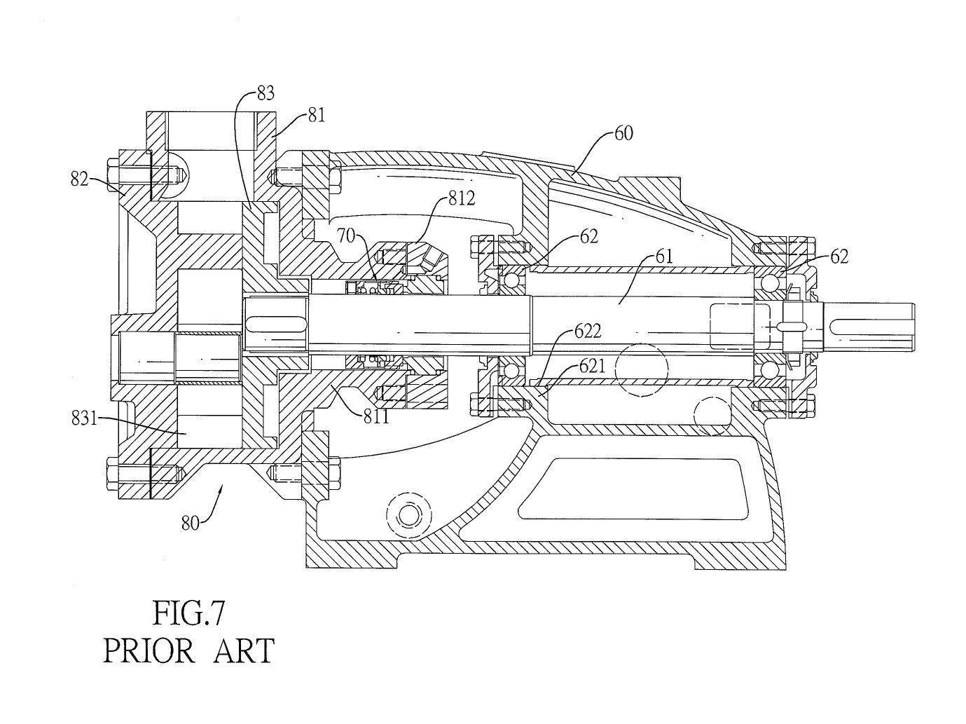

### DETAILED DESCRIPTION OF THE PREFERRED EMBODIMENTS

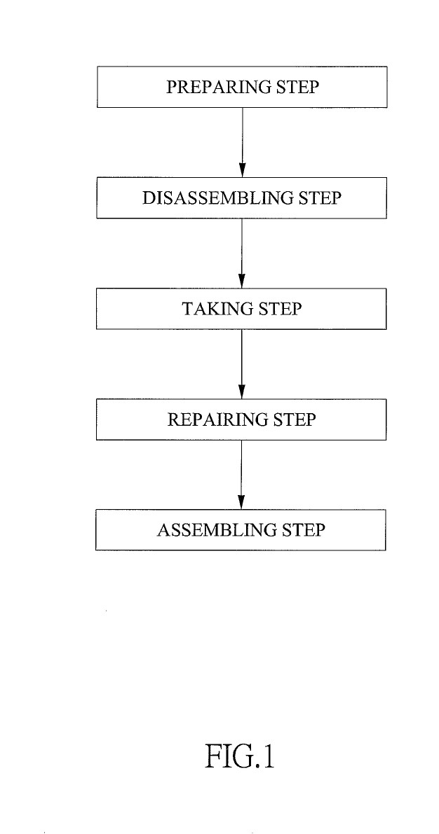

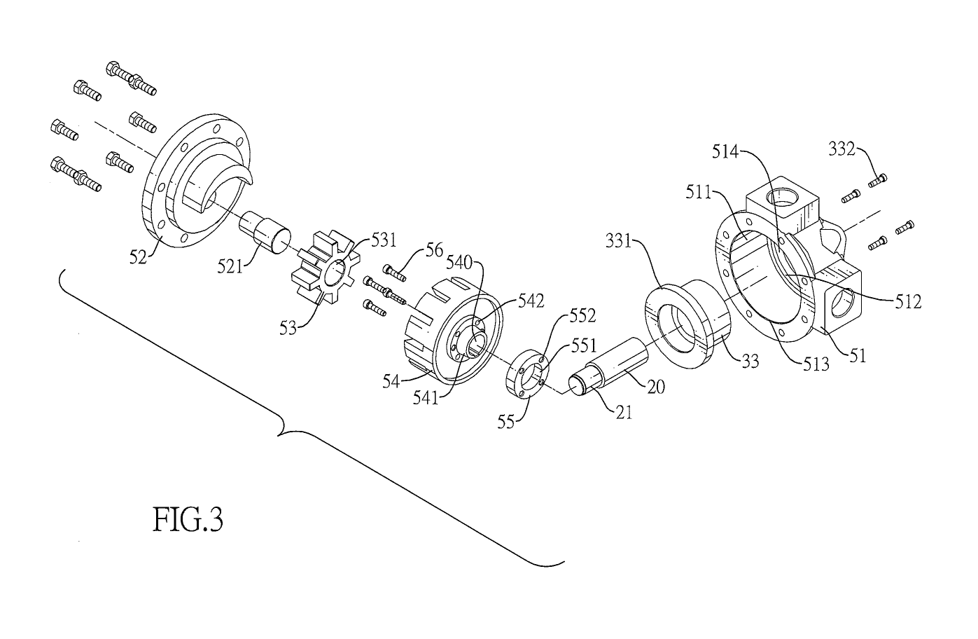

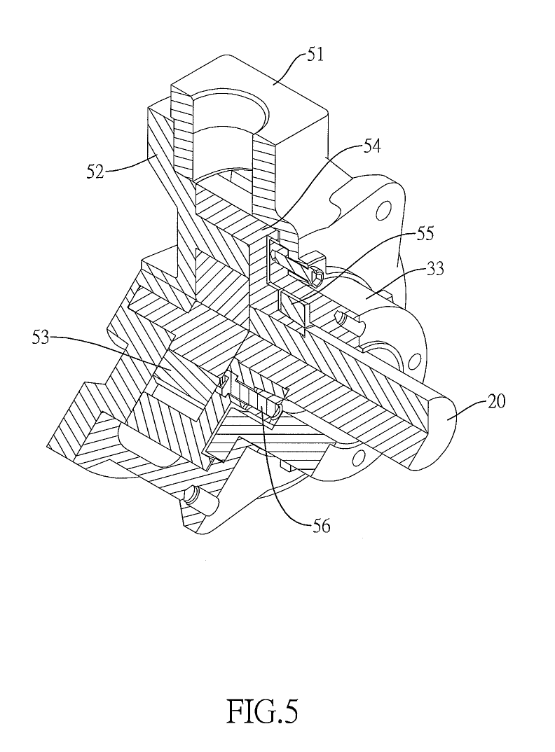

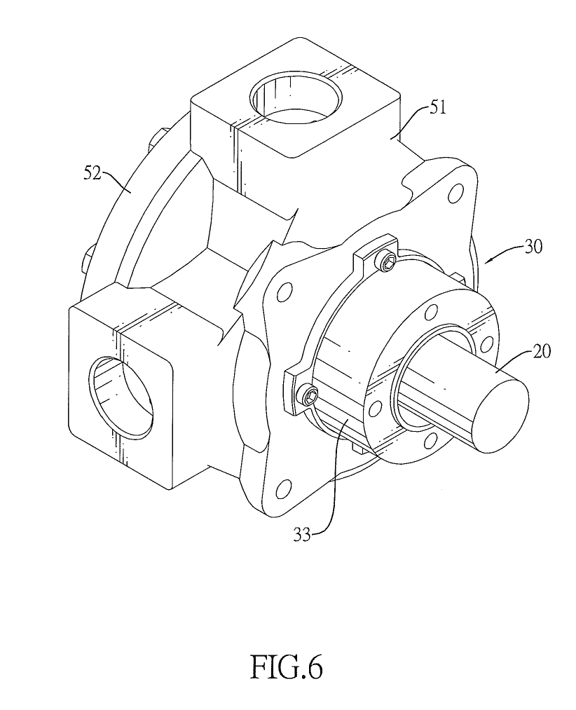

With reference to FIGS. 1 to 6, a method of assembling and repairing an internal-rotation type gear pump in accordance with the present invention comprises a preparing step, a disassembling step, a taking step, a repairing step and an assembling step.

The preparing step comprises preparing an internal-rotation type gear pump. The internal-rotation type gear pump has a bearing mount device, a gland-sealing device 30 and a pump device 50.

The bearing mount device has a bearing mount 10 and a driving shaft 20.

The bearing mount 10 is hollow and has a front end, a rear end, a middle, two openings, two mounting bases 12, two bearings 11, 13, two bearing caps 14 and multiple side holes 15. The openings are respectively formed in the ends of the bearing mount 10. The mounting bases 12 are respectively formed on and protrude form the middle and the rear end of the bearing mount 10 and each mounting base 12 has an outer surface opposite each other. The bearings 11, 13 are respectively mounted in the mounting bases 12. The bearing caps 14 are respectively mounted securely on the outer surfaces of the mounting bases 12. The side holes 15 are formed through the bearing mount 10 at intervals near the front end of the bearing mount 10.

The driving shaft 20 is rotatably mounted in the bearing mount 10 and has a front end, a rear end and a connecting post 21. The ends of the driving shaft 20 respectively extend out of the openings of the bearing mount 10. The rear end of the driving shaft 20 is connected to a motive force such as a motor to enable the driving shaft 20 to rotate relative to the bearing mount 10. The connecting post 21 is formed on and protrudes from the front end of the driving shaft 20 and has an external surface and a key. The key is formed on and protrudes from the external surface of the connecting post 21.

The gland-sealing device 30 is connected to the bearing mount device and has a sealing sheath 33, a mechanical gland seal 31 and a sealing cover 32.

The sealing sheath 33 is detachably connected to the front end of the bearing mount 10, is mounted around the driving shaft 20 near the connecting post 21 and has a rear side, a front side, a mounting flange 331 and multiple fasteners 332. The rear side of the sealing sheath 33 faces the bearing cap 14 that is mounted on the middle of the bearing mount 10. The mounting flange 331 is annularly formed on the front side of the sealing sheath 33. The fasteners 332 are mounted through the mounting flange 331.

The mechanical gland seal 31 is mounted in the sealing sheath 33, is mounted around the front end of the driving shaft 20 near the connecting post 21 and has a rotating ring and a stationary ring. The rotating ring of the mechanical gland seal 31 is mounted securely around the driving shaft 20. The stationary ring is mounted around the driving shaft 20 and abuts with the rotating ring of the mechanical gland seal 31.

The sealing cover 32 is mounted on the rear side of the sealing sheath 33, is mounted around the driving shaft 20 and is connected to the stationary ring of the mechanical gland seal 31.

The pump device 50 is detachably connected to the bearing mount device and the gland-sealing device 30 and has a casing 51, a side cover 52, a driven gear 53, a driving gear 54 and a holding ring 55.

The casing 51 is detachably connected to the front end of the bearing mount 10 and the sealing sheath 33 and has a front side, a rear side, an external surface, an internal surface, a chamber 511, a rear opening 514, a front opening 513, an inlet, an outlet and a step flange 512.

The chamber 511 is formed in the casing 51 between the sides of the casing 51 and has a diameter. The rear opening 514 is formed through the rear side of the casing 51, communicates with the chamber 511 and is mounted around the sealing sheath 33 and has a diameter smaller than the diameter of the chamber 511. The front opening 513 is formed through the front side of the casing 51 and communicates with the chamber 511 of the casing 51. The inlet and the outlet are formed through the external surface of the casing 51 and communicate with the chamber 511 of the casing 51. The step flange 512 is formed on the internal surface of the casing 51 at the rear opening 514 and is mounted around and connected securely to the mounting flange 331 of the sealing sheath 33 by the fasteners 332.

The side cover 52 is mounted securely on the front side of the casing 51 to cover the front opening 513 and has a mounting rod 521. The mounting rod 521 is mounted on the side cover 52, extends in the chamber 511 of the casing and misaligns with the driving shaft 20. The driven gear 53 is mounted around the mounting rod 521 in the side cover 52 and has a center and a rod hole 531. The rod hole 531 is formed through the center of the driven gear 53 and is mounted around the mounting rod of the side cover 52.

The driving gear 54 is mounted around the connecting post 21 of the driving shaft 20, is rotatably mounted in the chamber 511 of the casing 51 and engages the driven gear 53 and has an engaging side, a mounting side, a center, a taper sleeve 541, a shaft hole 540 and multiple through holes 542. The engaging side of the driving gear 54 engages the driven gear 53. The mounting side of the driving gear 54 faces the mounting flange 331 of the sealing sheath 33.

The taper sleeve 541 is formed on and protrudes from the mounting side of the driving gear 541 at the center of the driving gear 54 and is mounted around the connecting post 21 of the driving shaft 20 and has an external cone surface. The shaft hole 540 is formed through the taper sleeve 541 and the center of the driving gear 54, is mounted around the connecting post 21 of the driving shaft 20 and has a key recess securely mounted around the key of the connecting post 21 to enable the driving gear 54 to rotate with the driving shaft 20. The through holes 542 are formed through the mounting side of the driving gear 54 around the taper sleeve 541.

The holding ring 55 is mounted around the taper sleeve 541 of the driving gear 54 and has a holding hole, multiple threaded holes 552 and multiple screw elements 56. Preferably, an interval may be defined between the holding ring 55 and the mounting side of the driving gear 54. The holding hole is formed through the holding ring 55, is mounted around the taper sleeve 541 of the driving gear 54 and has an internal cone surface 551 corresponding to the external cone surface of the taper sleeve 541. The threaded holes 552 are foamed through the holding ring 55 around the holding hole of the holding ring 55 and respectively align with the through holes 542 of the driving gear 54.

The screw elements 56 are mounted through the through holes 542 of the driving gear 54 and are screwed with the threaded holes 552 of the holding ring 55 to hold the holding ring 55 with the taper sleeve 541 of the driving gear 54. When the screw elements 56 are securely screwed with the threaded holes 552 of the holding ring 55, the internal cone surface 551 of the holding ring 55 that abuts with the external cone surface of the taper sleeve 541 can compress the taper sleeve 541 to mount securely around the connecting post 21 of the driving shaft 20. Thus, the driving gear 54 can be held securely with the driving shaft 20 to transport motive force to the driven gear 53.

Preferably, in the preparing step, the driving gear 54 can be taken out of the casing 51 from the front opening 513 of the casing 51 and the gland-sealing device 30 can be taken out of the casing 51 from the rear opening 514 of the casing 51 by inserting a hand tool into one of the side holes 15 of the bearing mount 10 to loosen the fasteners 332 between the sealing sheath 33 and the casing 51.

The disassembling step comprises disassembling the side cover 52 from the casing 51 via the front opening 513 of the casing 51, disassembling and separating the driven gear 53 in the side cover 52 from the driving shaft 20 and disassembling the driving gear 54 from the driving shaft 20 via the front opening 513 of the casing 51.

The taking step comprises separating the gland-sealing device 30 from the driving shaft 20 and taking the gland-sealing device 30 out of the casing 51 of the pump device 50 via the rear opening 514 to the front opening 513 of the casing 51. Preferably, in the taking step, the sealing sheath 33 is taken out of the casing 51 from the step flange 512 by loosening the fasteners 332 via the side holes 15 of the bearing mount 10 and is separated from the sealing cover 32. Then, the mechanical gland seal 31 and the sealing cover 32 are taken out of the casing 51 from the driving shaft 20 in a consecutive order.

The repairing step comprises repairing the mechanisms, such as the driving gear 54 or the gland-sealing device 30 inside the internal-rotation type gear pump and replacing with a new one of the driving gear 54 or the gland-sealing device 30 if one of the mechanisms inside the internal-rotation type gear pump is broken.

The assembling step comprises putting the repaired or new gland-sealing device 30 into the casing 51 via the front opening 513 of the casing 51 to mount around the driving shaft 20 by fastening the fasteners 332 between the sealing sheath 33 and the casing 51 via the side holes 15 of the bearing mount 10, assembling the driving gear 54 on the driving shaft 20 in the casing 51 and assembling the side cover 52 on the casing 51 to cover the front opening 513 and to enable the driven gear 53 to engage the driving gear 54.

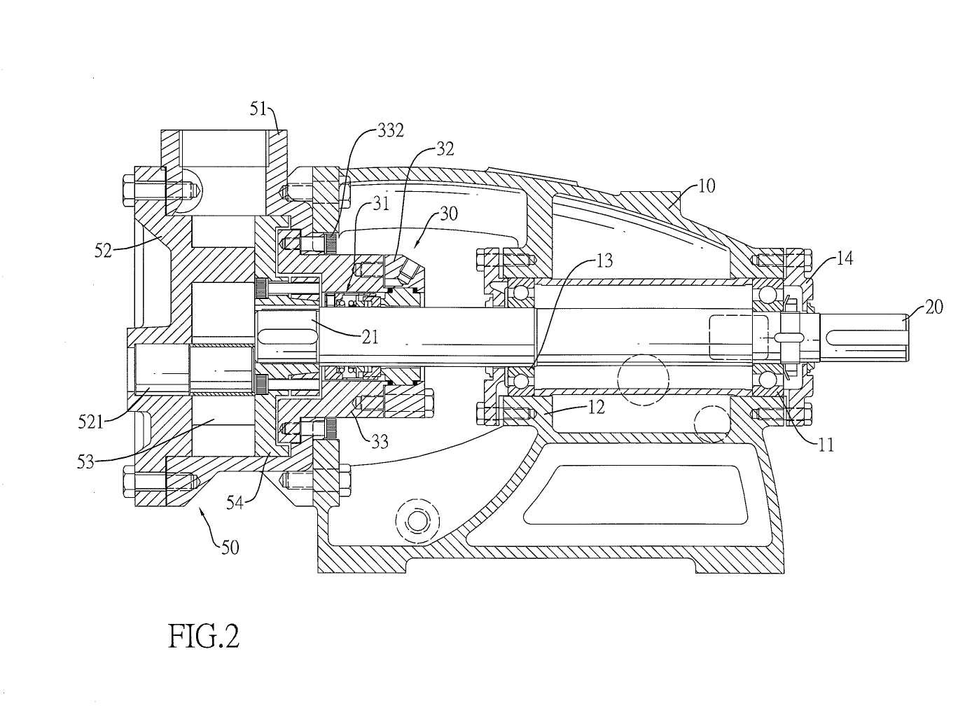

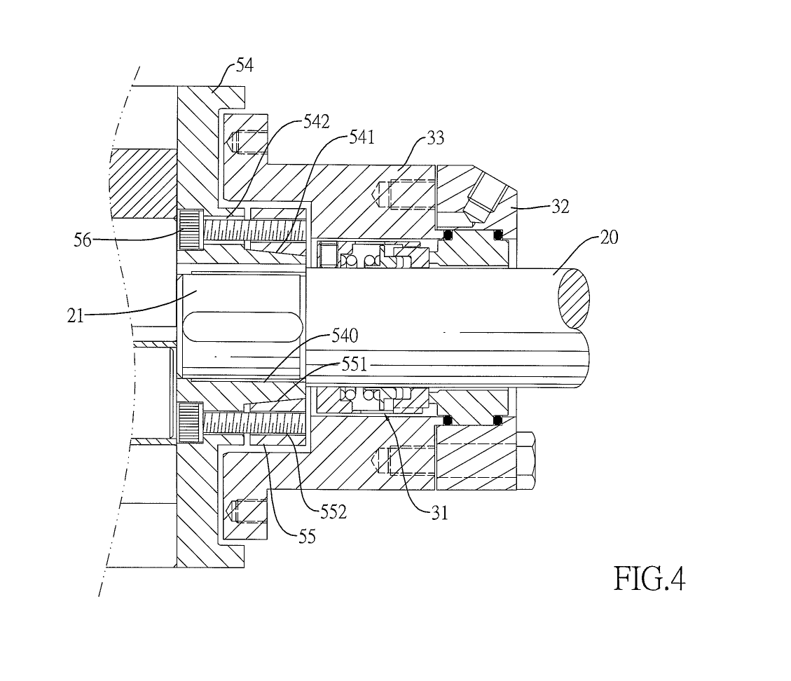

With further reference to FIGS. 2 and 4, the method of assembling an internal-rotation type gear pump in accordance with the present invention only requires disassembling the side cover 52 of the pump device 50 from the casing 51 to allow the driven gear 53 to separate from the driving gear 54. The mechanisms such as the driving gear 54 or the gland-sealing device 30 inside the internal-rotation type gear pump can be repaired or replaced by loosening the screw elements 56 and the fasteners 332 between the driving gear 54, the holding ring 55, the sealing sheath 33 and the casing 51 without disassembling the casing 51, the bearing mount 10, the bearings 11, 13 and the driving shaft 20. In addition, the user also can disassemble the driving gear 54 from the driving shaft 20 by loosening the screw elements 56 between the driving gear 54 and the holding ring 55. Furthermore, the sealing sheath 33, the sealing cover 32 and the mechanical gland seal 31 of the gland-sealing device 30 can be disassembled from the casing 51 and the driving shaft 20 by inserting a hand tool into one of the side holes 15 of the bearing mount 10 to loosen the fasteners 332 between the sealing sheath 33 and the casing 51 to be repaired or replaced conveniently. After repairing the internal-rotation type gear pump, the user only needs to assemble the inside mechanisms of the internal-rotation type gear pump in a reverse order to that of the taking step.

Therefore, by the method of assembling an internal-rotation type gear pump in accordance with the present invention, the casing 51, the bearing mount 10, the bearings 11, 13 and the driving shaft 20 are fixed without disassembling when the inside mechanisms of the internal-rotation type gear pump have to be repaired or replaced and this can decrease the time of assembling or disassembling the internal-rotation type gear pump and can repair or replace the internal-rotation type gear pump conveniently.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A method of assembling and repairing an internal-rotation type gear pump comprising:
a preparing step comprising:
preparing an internal-rotation type gear pump with a bearing mount, a driving shaft rotatably mounted in the bearing mount, a gland-sealing device mounted around the driving shaft and connected to a front end of the bearing mount with a sealing sheath, a mechanical gland seal mounted in the sealing sheath, a sealing cover mounted on the sealing sheath and a pump device with a casing connected to the front end of the bearing mount and the sealing sheath and having a rear opening, a front opening and a step flange formed in the casing near the rear opening, a side cover mounted securely on the casing to cover the front opening, a driven gear mounted in the side cover and a driving gear mounted around the driving shaft, rotatably mounted in the casing and engaging the driven gear;
a disassembling step comprising:
disassembling the side cover from the casing via the front opening of the casing;
disassembling and separating the driven gear in the side cover from the driving gear; and
disassembling the driving gear from the driving shaft via the front opening of the casing;
a taking step comprising:
separating the gland-sealing device from the driving shaft; and
taking the gland-sealing device out of the casing of the pump device via the rear opening to the front opening of the casing;
a repairing step comprising:
repairing the mechanisms inside the internal-rotation type gear pump; and
replacing with a new one of the driving gear and the gland-sealing device if one of the mechanisms inside the internal-rotation type gear pump is broken; and
an assembling step comprising:
putting the repaired or new gland-sealing device into the casing via the front opening of the casing to mount around the driving shaft;
assembling the repaired or new driving gear on the driving shaft in the casing; and
assembling the side cover on the casing to cover the front opening and to enable the driven gear to engage the driving gear.

2. The method as claimed in claim 1, wherein the preparing step comprises
forming the front opening of the casing having a diameter larger than that of the driving gear to allow the driving gear to pass through;
forming the rear opening of the casing having a diameter larger than that of the gland-sealing device to allow the gland-sealing device to pass through; and
forming multiple side holes through the bearing mount at intervals near the front end of the bearing mount.

3. The method as claimed in claim 2, wherein the taking step comprises
taking the sealing sheath out of the casing from the step flange by inserting a hand tool into one of the side holes of the bearing mount to loosen the sealing sheath from the casing and separating the sealing sheath from the sealing cover;
taking the mechanical gland seal out of the casing from the driving shaft; and
taking the sealing cover out of the casing from the driving shaft.

4. The method as claimed in claim 1, wherein the taking step comprises
taking the sealing sheath out of the casing from the step flange and separating the sealing sheath from the sealing cover;
taking the mechanical gland seal out of the casing from the driving shaft; and
taking the sealing cover out of the casing from the driving shaft.

5. An internal-rotation type gear pump comprising:
a bearing mount being hollow and having
a front end;
a rear end;
a middle;
two openings respectively formed in the ends of the bearing mount;
two bearings respectively mounted in the bearing mount at the rear end and the middle of the bearing mount; and
multiple side holes formed through the bearing mount at intervals near the front end of the bearing mount;
a driving shaft rotatably mounted in the bearings of the bearing mount and having a front end and a rear end respectively extending out of the openings of the bearing mount;
a gland-sealing device connected to the bearing mount and the driving shaft and having
a sealing sheath detachably connected to the front end of the bearing mount, mounted around the driving shaft and having
a rear side facing the middle of the bearing mount;
a front side;
a mounting flange annularly formed on the front side of the sealing sheath; and
multiple fasteners mounted through the mounting flange;
a mechanical gland seal mounted in the sealing sheath and securely mounted around the front end of the driving shaft; and
a sealing cover mounted on the rear side of the sealing sheath, mounted around the driving shaft and connected to the mechanical gland seal; and
a pump device detachably connected to the bearing mount, the driving shaft and the gland-sealing device and having
a casing detachably connected to the front end of the bearing mount and the sealing sheath and having
a front side;
a rear side;
a chamber formed in the casing between the sides of the casing;
a rear opening formed through the rear side of the casing, communicating with the chamber and mounted around the sealing sheath; and
a front opening formed through the front side of the casing and communicating with the chamber of the casing;
a side cover mounted securely on the front side of the casing to cover the front opening;
a driven gear rotatably mounted in the side cover; and
a driving gear mounted around the driving shaft, rotatably mounted in the chamber of the casing and engaging the driven gear.

6. The internal-rotation type gear pump as claimed in claim 5, wherein the casing has
an internal surface; and
a step flange formed on the internal surface of the casing at the rear opening and mounted around and connected securely to the mounting flange of the sealing sheath by the fasteners.

7. The internal-rotation type gear pump as claimed in claim 6, wherein
the driving gear has
an engaging side engaging the driven gear;
a mounting side facing the mounting flange of the sealing sheath;
a center;
a taper sleeve formed on and protruding from the mounting side of the driving gear at the center of the driving gear and mounted around the connecting post of the driving shaft and having an external cone surface;
a shaft hole formed through the taper sleeve and the center of the driving gear and mounted around the driving shaft; and
multiple through holes formed through the mounting side of the driving gear around the taper sleeve; and
the pump device has a holding ring mounted around the taper sleeve of the driving gear and having
a holding hole formed through the holding ring, mounted around the taper sleeve of the driving gear and having an internal cone surface corresponding to the external cone surface of the taper sleeve;
multiple threaded holes formed through the holding ring around the holding hole of the holding ring and respectively aligning with the through holes of the driving gear; and
multiple screw elements mounted through the through holes of the driving gear and screwed with the threaded holes of the holding ring to hold the holding ring with the taper sleeve of the driving gear.

8. The internal-rotation type gear pump as claimed in claim 5, wherein
the driving gear has
an engaging side engaging the driven gear;
a mounting side facing the mounting flange of the sealing sheath;
a center;
a taper sleeve formed on and protruding from the mounting side of the driving gear at the center of the driving gear and mounted around the connecting post of the driving shaft and having an external cone surface;
a shaft hole formed through the taper sleeve and the center of the driving gear and mounted around the driving shaft; and
multiple through holes formed through the mounting side of the driving gear around the taper sleeve; and
the pump device has a holding ring mounted around the taper sleeve of the driving gear and having
a holding hole formed through the holding ring, mounted around the taper sleeve of the driving gear and having an internal cone surface corresponding to the external cone surface of the taper sleeve;
multiple threaded holes formed through the holding ring around the holding hole of the holding ring and respectively aligning with the through holes of the driving gear; and
multiple screw elements mounted through the through holes of the driving gear and screwed with the threaded holes of the holding ring to hold the holding ring with the taper sleeve of the driving gear.
